(19) United States
(12) Patent Application Publication
(10) Pub. No.: US 2025/0224537 A1
(43) Pub. Date: Jul. 10, 2025

(54) METHOD TO GENERATE SALINITY CURVES FOR EVAPORITE PRODUCTION MODELING IN PERITIDAL CARBONATE PLATFORMS

(71) Applicant: SAUDI ARABIAN OIL COMPANY, Dharan (SA)

(72) Inventors: Xiaoxi Wang, Beijing (CN); Peng Lu, Dhahran (SA); Rainer Zuhlke, Dhahran (SA)

(73) Assignee: SAUDI ARABIAN OIL COMPANY, Dharan (SA)

(21) Appl. No.: 18/703,857

(22) PCT Filed: Jun. 30, 2023
(86) PCT No.: PCT/CN2023/104641

§ 371 Date: Apr. 23, 2024

(51) Int. Cl. G01V 20/00

(52) U.S. Cl. CPC G01V 20/00

(57) ABSTRACT

A method for predicting a mineral composition of an evaporite penetrated by a first portion of a wellbore following a planned wellbore path through a sedimentary basin and determining an observed mineral composition of the evaporite. A non-transitory computer readable medium storing instructions executable by a computer processor including receiving a history of sea-level for a sedimentary basin, using a seawater evaporation model to predict a salinity threshold and produce a seawater evaporation curve, where the seawater evaporation curve includes an amount of minerals contained in a body of seawater as a function of salinity, identifying depositional portions of the history of sea-level, and developing a mathematical model to generate the geological-time dependent salinity curve based on the depositional portions of the history of sea-level.

### BACKGROUND

Evaporites are a class of sedimentary minerals and rocks that form by precipitation from evaporating aqueous fluid. Common evaporite minerals are halite, gypsum and anhydrite, which can form as seawater evaporates, as well as the rocks limestone and dolostone. Certain evaporite minerals, particularly halite, can form excellent cap rocks or seals for hydrocarbon traps because they have minimal porosity, and they tend to deform plastically (as opposed to brittle fracturing that would facilitate leakage of oil and gas).

Evaporites require local seawater to be supersaturated with respect to a single or several specific evaporative minerals to allow for precipitation. Salinity, i.e., the dissolved salt content of a body of water, is a good measurement of the degree of saturation (i.e., saturation index) with respect to a specific evaporative mineral. Precipitation follows an on-and-off switch: the mineral precipitates when salinity is higher than a specific salinity threshold (e.g., superstaturated to the mineral), but precipitation stops when salinity is lower than the threshold. Extensive evaporite units provide regional top and/or lateral seals for hydrocarbon reservoirs, such as stacked carbonate-evaporite units. In addition, due to the mobility, solubility, and ductility of evaporites, evaporite layers are prone to spatial alteration during burial.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for predicting a predicted mineral composition of an evaporite penetrated by a first portion of a wellbore following a planned wellbore path through a sedimentary basin. Embodiments also relate to determining an observed mineral composition of the evaporite, updating the planned wellbore path based, at least in part, on the predicted mineral composition and the observed mineral composition and drilling, using a drilling system, a second portion of the wellbore, guided by the updated planned wellbore path.

In another aspect, embodiments disclosed herein relate to a non-transitory computer readable medium storing instructions executable by a computer processor. The instructions when executed by a computer processor include receiving a history of sea-level for a sedimentary basin, using a seawater evaporation model to predict a salinity threshold and produce a seawater evaporation curve, where the seawater evaporation curve includes an amount of minerals contained in a body of seawater as a function of salinity, identifying depositional portions of the history of sea-level, and developing a mathematical model to generate the geological-time dependent salinity curve based on the depositional portions of the history of sea-level.

In another aspect, embodiments disclosed herein relate to a system, including a geological-time dependent salinity curve configured to predict a predicted mineral composition in a sedimentary basin, a drilling system, configured to drill a wellbore through the sedimentary basin, and a calibrated geological-time dependent salinity curve, configured to predict a second mineral composition based on an observed mineral composition.

Other aspects and advantages of the claimed subject matter will be apparent from the following description and the appended claims.

### BRIEF DESCRIPTION OF DRAWINGS

FIG. 1 shows an example sedimentary basin.

FIGS. 2A-2B show systems in accordance with one or more embodiments.

FIG. 3 shows a method in accordance with one or more embodiments.

FIG. 4 shows a system in accordance with one or more embodiments.

FIG. 5 shows a flowchart in accordance with the method of one or more embodiments.

FIGS. 6-18B show examples in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” “about,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

In the following description of the figures, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Seal availability and continuity have been recognized as one of the major well exploration risks in both carbonate and clastic reservoirs. Because evaporites seal about 50% of the world's known total petroleum reserves, accurate prediction of evaporite existence in a wellbore is needed for successful exploration and production in the petroleum industry. The complex interplay of evaporite formation, diagenesis and structural evolution needs to be systematically understood and modelled in order to accurately predict the position and quality of evaporite traps. Because high salinity is required to trigger evaporite precipitation, salinity evolution during sedimentation may be used to predict the existence, areal extension, and thickness of evaporite interlayers in stacked carbonate reservoirs and seal units. Geological-age dependent salinity curves which predict mineral compositions of an evaporite formation in a wellbore are not currently available. Thus, depositional modeling does not currently differentiate or individually process-model critical parameters including evaporite formation factory (aerial coverage, brine volume, evaporite mineralogy and rate of progressive formation of main evaporite types). Therefore, current numerical modeling of evaporite sedimentary basins bears significant limitations. The present disclosure relates to a methodology to expand depositional models and overcome these limitations by incorporating salinity modeling.

In general, embodiments disclosed herein relate to a method for determining the mineral composition in a sedimentary basin of a hydrocarbon reservoir using a geological-age dependent salinity curve. The salinity curve is generated using a mathematical model developed in embodiments disclosed herein. Embodiments disclosed herein also relate to a method and system for analyzing hydrocarbon reservoir properties while drilling or operating a well using a salinity curve and calibrating the salinity curve to improve geosteering and overpressure management operations in situ.

A sedimentary basin is defined as a collection of rocks formed by deposition of minerals on or near Earth's surface by geological processes such as erosion, weathering, dissolution, precipitation, and lithification. Almost all of the world's oil and natural gas are contained in sedimentary rock, and therefore improved understanding of sedimentary basins can improve operations in the oil and gas industry.

After the formation of sedimentary basins, oil and natural gas migrate from source rocks (i.e., rocks where oil and gas are originally formed) to reservoir rocks, composed largely of sedimentary rocks, as a consequence of low density of the hydrocarbon fluids and gases. Sedimentary rocks with good hydrocarbon potential must therefore have high porosity and permeability. High porosity allows the rock to store migrating petroleum, and high permeability, defined as the interconnectedness of the pores, allows for easier withdrawal of the petroleum during drilling. Two common types of rocks contained in sedimentary basins are carbonates and evaporites. Evaporites, which generally have very low permeabilities (e.g., less than 10-6 md) and porosities, are one of the most effective sedimentary rocks at sealing hydrocarbons. Although evaporites account for only 2% of the world's sedimentary rocks, they seal about 50% of the world's known total petroleum reserves. Carbonate reservoirs hold about 70% of oil and 90% of gas reserves in the Middle East and are characterized by highly heterogeneous porosity and permeability. The porosity and permeability of carbonates varies based on the environment in which they were originally deposited, as well as how the rock was altered over time. In general, carbonates have a higher permeability and porosity to hydrocarbons compared to evaporites.

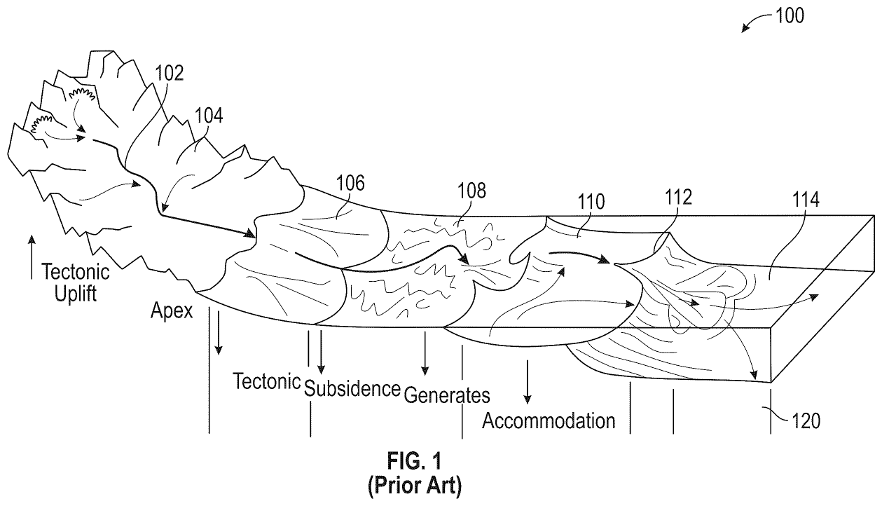

An example sedimentary basin is shown in FIG. 1. FIG. 1 illustrates a sedimentary basin formed by a progression of different grain types and grain sizes in a geologic region (100). In particular, a sedimentary basin may describe a sedimentary pathway from a sedimentary source location to a final sediment deposition, forming a sedimentary basin. For reservoir simulations, sedimentary pathway data may form input parameters to comprehensive numerical modeling of sedimentary basins, e.g., forward depositional-diagenetic modelling.

In FIG. 1, the geologic region (100) includes a sedimentary pathway (102) that includes a variety of rock grains of various sizes, shapes, and types. The sedimentary pathway (102) starts at a catchment (104) and flows through a gravel alluvial fan (106), an alluvial plain (108), a coastal fence (110), and a shelf-slope break (112) before settling in a deep marine basin (114). Within this sedimentary pathway (102), different types of grains may be categorized according to different facies such as sand or fine-grain deposits. As the sedimentary pathway (102) passes through various zones, different-sized grains may get deposited along the sedimentary pathway and exit the load of sediment (102). In particular, the larger, heavier, and coarser sediment particles may depart from a sediment flow earlier than the smaller, lighter, finer sediment particles, such as sand. The sedimentary pathway (102) may have a sedimentary source that originates sedimentary particles for deposition along the sedimentary pathway (102).

Depending on the ionic composition of seawater in the marine basin from which the sedimentary basin of FIG. 1 forms, different types of sedimentary rocks such as carbonates or evaporites may be deposited along the sedimentary pathway. Sedimentary basins originally formed over the course of millions of years during the Earth's history. In addition to the original depositional sequence of a sedimentary basin, time based processes such as shifting tectonic plates, erosion, compaction, and cooling can alter the composition and location of certain minerals contained in sedimentary basins over time.

Many different theories and models exist to determine the composition of sedimentary basins at a specific location beneath the Earth's surface. Because evaporites precipitate from seawater, it is crucial to know information about the seawater's history in order to predict the presence of evaporites. It is well known that the position of a sea's shoreline is not constant and may change by three major processes: tectonic uplift/subsidence, eustatic sea-level rise/fall, and sedimentation. How, where, and the rate at which these three processes occur determines the depositional sequence of sedimentary basins. In general, if there is a relative sea-level rise, the shoreline will move landward, which is known as transgression. During transgression, the shoreline moves to a position that used to be occupied by land. Regression occurs when the sea becomes shallower, either due to a relative sea-level fall or a deposition of sediment. Evidence for seawater level can therefore be determined by the characteristic sediments deposited at different positions relative to the sea's shoreline at any point in geological-time.

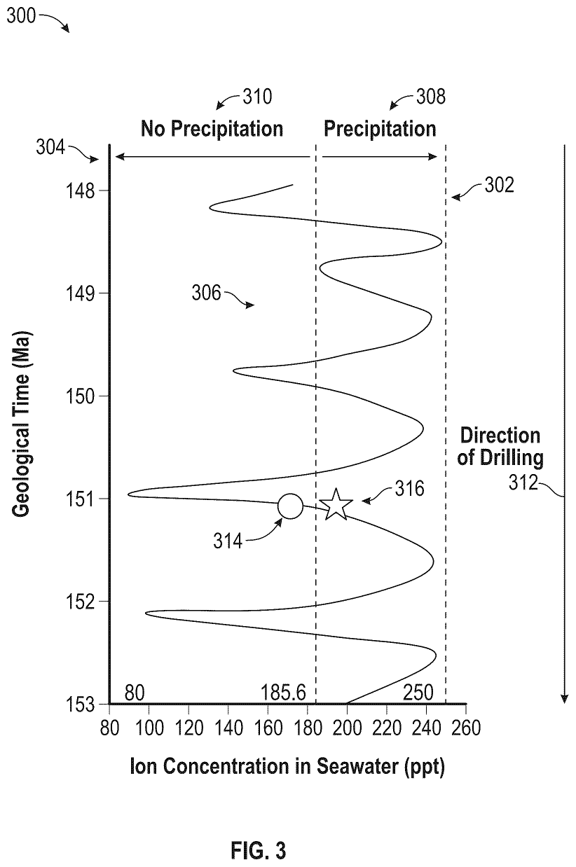

Because evaporites form from aqueous mineral solutions, the ion composition of a body of seawater may also be used to predict the mineral composition of an evaporite. In one or more embodiments, the ion composition of a body of seawater is used as input data to develop a geological-age dependent salinity curve (such as the one shown in FIG. 3, which will be discussed in more detail in the following sections). A salinity curve is defined herein as the concentration of an ion in seawater reported in grams/liter (g/L) as a function of a geological time period (reported in million years, or Ma). In one or more embodiments, the geological-age dependent salinity curve is used to predict a mineral composition of an evaporite in a sedimentary basin.

Currently, geological-age dependent salinity curves which model evaporite deposition in sedimentary basins are not available. Because of this, depositional modeling codes do not differentiate or individually process model critical parameters including evaporite formation factors (e.g., aerial coverage, brine volume, evaporite mineralogy), evaporite chemical processes, and rate of progressive formation of main evaporite types. Therefore, current numerical models of evaporite sedimentary basins bear significant limitations. One or more embodiments disclosed herein describes a method and a mathematical model to generate salinity curves for evaporite sedimentary basins based on salinity threshold, salinity limits, eustatic (or relative) sea-level changes, and depositional features.

One or more embodiments relate to using a seawater evaporation model to define the salinity threshold and amount of mineral produced as a function of salinity for different evaporite minerals (e.g., anhydrite and halite) useful in generating geological-time dependent salinity curves. To model seawater evaporation, pure water (i.e., no ions) is sequentially removed from a saltwater system, thereby progressively concentrating the ion content. As more and more pure water is removed, the ion concentrations (e.g., Na⁺, K⁺, Cl⁻, SO4⁻²) will rise accordingly. Once a specific ion reaches a high enough concentration (also known as the salinity threshold), a mineral will gradually precipitate. In some cases, multiple minerals can reach the salinity threshold at the same time when the seawater is concentrating, and these minerals will precipitate together. The geochemical equilibrium model (Equation 1) may be used to predict aqueous component concentrations, and mineral (or salt) solubility. The geochemical equilibrium model uses laws of mass action, as well as mass and charge balance. Mineral (or salt) solubility is measured by its saturation index (SI), which is defined as:

$$SI = log ( IAP / Ksp ) \qquad ( Equation 1 )$$

where IAP is the ion activity product and Ksp is the equilibrium solubility product. For a mineral compound, AₐB_{b} (where A is the cation species of the compound, and B is the anion species), its Ksp is {A}^{a} {B}^{b} at equilibrium and IAP is {A}^{a} {B}^{b} for the real solution, where { } is the ionic activities.

When the saturation index, SI, is equal to zero, the mineral is at equilibrium and has the tendency to precipitate. The exchange of gases, such as CO₂, between the seawater and atmosphere must also be accounted for in the seawater evaporation model. Once seawater is at equilibrium or slightly supersaturated with a specific mineral (i.e., when the saturation index is zero or greater than zero), the mineral starts to precipitate and will continue to precipitate as the evaporation of seawater continues. The concentration of a specific mineral which provides a saturation index of zero is defined as the salinity threshold. The salinity threshold is not a constant value for a mineral of interest; it depends on environmental factors such as temperature and types and concentration of gases exchanged with the seawater. Therefore, the salinity threshold calculated for a mineral of interest in accordance with one or more embodiments described herein will vary with geological-time and location. Salinities for a mineral to precipitate is geological-time dependent and it is well known that seawater composition underwent significant changes during Earth's history, thus the salinity required for a specific mineral to precipitate will be different if the seawater composition or time-period of interest changes.

Environmental gas levels and exchange between seawater and atmosphere, e.g., CO₂ exchange, may be useful in determining the saturation index of carbonate minerals (e.g., calcite, aragonite, dolomite), but may not be as helpful for evaporative minerals such as halite (NaCl), gypsum (CaSO₄:2H₂O), anhydrite (CaSO₄), bischofite (MgCl₂:6H₂O), carnallite (KMgCl₃:6H₂O), and sylvite (KCl). Therefore, while the geochemical equilibrium model (Equation 1, above) may account for environmental gas levels and exchanges, such parameters may be optional (omitted or included) in seawater evaporation models according to one or more embodiments of the present disclosure. For example, knowing the CO₂ concentrations during the depositional history of interest (not a constant), the geochemical equilibrium model may include calculating the gas-water equilibrium using CO₂ solubility coefficient, e.g., using the Peng-Robinson Equation of State. The amount of CO₂ dissolved may be calculated and used to determine the activity's effect on the SI of carbonate minerals.

The cumulative amounts of minerals precipitated from a body of seawater when it has reached and maintained equilibrium of the minerals as a function of salinity is defined herein as a seawater evaporation curve. In one or more embodiments, a seawater evaporation curve is used to predict a sequence of minerals that precipitate during evaporation of seawater (e.g., gypsum and halite). The salinity of seawater during evaporation may be monitored continuously and the total amount by weight of dissolved minerals in one kilogram of seawater (reported in units of parts per thousand, ppt or % 0) may be calculated.

The Harvie-Møller-Weare (HMW) model was developed in 1984 to predict the mineral solubility of an eight-ion component system at 25° C., as described in Harvie, C. E., Moller, N., Weare, J. H., The prediction of mineral solubilities in natural waters: the Na—K—Mg—Ca—H—Cl—SO₄—OH—HCO₃—CO₃—CO₂—H₂O system to high ionic strengths at 25° C., Geochimica et Cosmochimica Act, Vol. 48, pp. 723-751, which is hereby incorporated by reference. The HMW model uses polynomial equations to calculate electrolyte activities, which can be applied with accuracy at high ionic strength in compositionally complex fluids. The HMW model, more generally known as the Pitzer model, is an empirical model used to calculate electrolyte activities of brines and other electrolyte solutions with high concentrations. Generally, it has a set of equations with many fitting parameters to match experimental data. The Pitzer equations used in the HMW model are described in Plummer, L. N., Parkhurst, D. L., Fleming, G. W., Dunkle, S. A., A Computer Program Incorporating Pitzer's Equations for Calculation of Geochemical Reactions in Brines, U.S. Geological Survey, Water-Resources Investigations Report 88-4153, pp. 2-5, (1988), which is hereby incorporated by reference. Therefore, the HMW model is suitable for seawater evaporation model calculations to define the salinity threshold and amount of mineral produced as a function of salinity for different evaporite minerals according to the methods disclosed in one or more embodiments disclosed herein.

In one or more embodiments, the method to generate a seawater evaporation curve for an evaporite sedimentary basin of interest includes obtaining the major ion composition of modern seawater which corresponds to the geological region in which the evaporate sedimentary basin is contained. The major ion composition data is input into a geological modeling software in combination with the HMW model. The geological software used in embodiments disclosed herein is “PH Redox Equilibrium” (PHREEQC). PHREEQC is a computer program designed to perform various aqueous geochemical calculations. By inputting the major ion composition data and the HMW model into PHREEQC, a seawater evaporation curve for the evaporite sedimentary basin of interest may be calculated. Inputs to the PHREEQC software may include (1) the database used (pitzer.dat), (2) the chemical composition of the seawater (major ion composition, e.g., Na, Ca, Mg, K, Cl), (3) the evaporation reaction (negatively extracting the water), and (4) minerals of interest. The model output from the PHREEQC software may be tabular/ASCII format and can be opened with software (e.g., Microsoft Excel) to graphically present the output data.

An example of a seawater evaporation curve developed by the model described herein is shown in FIG. 6, which will be described in more detail in the following sections. In one or more embodiments, the generated seawater evaporation curve may be used to model mineral types, salinity threshold for a mineral to precipitate, and the amount of minerals produced as a function of salinity.

Table 1 summarizes ion types, concentrations (millimole, mmol), and salinity (parts per thousand, ppt) for different example water environments in evaporite basins. In Table 1, “seawater” refers to surface water, and the remaining four water environments are sub-environments of the Lake Macleod Evaporite basin in Western Australia. The salinity values of the water environments listed in Table 1 were investigated in order to define an upper and lower limit for anhydrite precipitation and therefore used to develop the mathematical model to generate salinity curves of one or more embodiments.

TABLE 1

| Ion type and | Water environment | | | | |
|---|---|---|---|---|---|
| Concentration, | | Cygnet | Ibis | Ralph | Phreatic |
| millimole (mmol) | Seawater | Pond | Pond | Sink | Majanna |
| Na⁺ | 485 | 674 | 1260 | 3180 | 4451 |
| Cl⁻ | 566 | 803 | 1460 | 3693 | 5350 |
| K⁺ | 10.6 | 12.78 | 25.56 | 65.6 | 103.8 |
| Ca²⁺ | 10.66 | 12.22 | 24.44 | 22.2 | 12.22 |
| Mg²⁺ | 55.1 | 80.56 | 137.2 | 339 | 597.8 |
| HCO₃⁻ | 2.407 | 1.622 | 0.7 | 1.67 | 1.655 |
| SO₄²⁻ | 29.3 | 41.76 | 77.8 | 137.2 | 211.1 |
| pH | 8.2 | 8.0 | 7.7 | 7.1 | 6.7 |
| Salinity (ppt) | 35 | 48 | 85 | 186 | 249 |

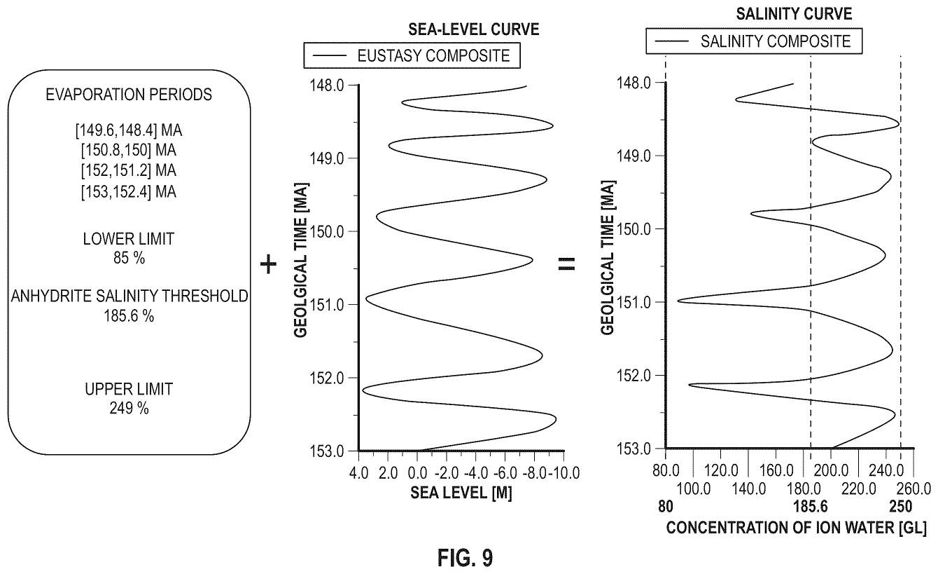

The method to develop a mathematical model to generate geological-time dependent salinity curves according to one or more embodiments also requires a history of the sea-level curve for the evaporite sedimentary basin of interest. In one or more embodiments, a sea-level curve used as input for generating geological-time dependent salinity curves may be obtained from literature data. The history of sea-level shows seawater level in meters (m) as a function of geological time (Ma). An example sea-level curve is shown in FIG. 9, which will be described in more detail in the following sections.

Two mathematical models were developed according to the method of one or more embodiments to generate an empirical salinity curve as a function of the eustatic (or relative) sea level, evaporation time periods, salinity limits, and evaporite salinity threshold. The mathematical models were developed by first determining the evaporation and non-evaporation periods by comprehensive geological study of the interest area based on geological history, well data, and seismic interpretation and sequence stratigraphic study. The sea-level changing curve (SL) are divided into segments corresponding to the evaporation periods (EP) and non-evaporation periods (Non EP). From the diagenetic modeling results, the salinity threshold (ST) is obtained. From the literature study, the upper limit of the salinity curve (UL) and the lower limit of the salinity curve (LL) are obtained. SL-EP segments are converted above the ST but not beyond the UL, and SL-Non EP are converted below the ST but not beyond the LL. This means that the original SL are converted to the salinity curve within the upper and lower limits and with the ST as a switch in the middle. For this purpose, two mathematical models are designed, shown in Equations 2 and 3 below. Equation 2 is used to generate an empirical salinity curve during evaporation periods, and Equation 3 is used to generate an empirical salinity curve during non-evaporation periods. The model may be applied universally, where different input parameters can change the variable a.

$${f ( SL , UL , LL , ST )}_{salinity curve} = \qquad [ Equation 2 ]$$

$$\{ \begin{matrix}( a \cdot SL - min ( {SL}_{EP} ) ) \times \frac{\vert UL - ST \vert}{\vert max ( SL ) \vert} + ST ( T ∈ EP ) \\ ( a \cdot SL - min ( {SL}_{EP} ) ) \times \frac{\vert LL - ST \vert}{\vert min ( SL ) \vert} + ST ( T ∈ Non EP )\end{matrix} \qquad [ Equation 3 ]$$

Where SL is the eustatic (or relative) sea-level curve (m), SL_{EP} is sea-level during evaporation periods, T is geological time, EP is evaporation periods (Ma), Non EP is non-evaporation periods, UL is upper limit (‰), LL is lower limit (‰), ST is evaporite salinity threshold (‰), a is a fitting parameter to make sure the first term (a·SL-min (SL_{EP})) is positive and normally has a value of −1.

In one or more embodiments, a mineral composition of an evaporite may be predicted based on a geological-age dependent salinity curve generated by the mathematical model of Equation 2 or Equation 3 for a sedimentary basin. Information regarding the mineral composition may be useful, for example, in drilling a well. Specifically, predicting the mineral composition of a geological area based on geological-time dependent salinity curves developed according to embodiments herein may help determine the location of sealing rocks (such as evaporites) and high porosity and high permeability rocks in hydrocarbon reservoirs (such as carbonates).

Embodiments disclosed herein also relate to a method and system for using a geological-time salinity curve for geosteering and overpressure management in a hydrocarbon reservoir and a method for analyzing hydrocarbon reservoir properties while drilling a well or operating a well and calibrating the salinity curve to correct geosteering and overpressure management operations in situ.

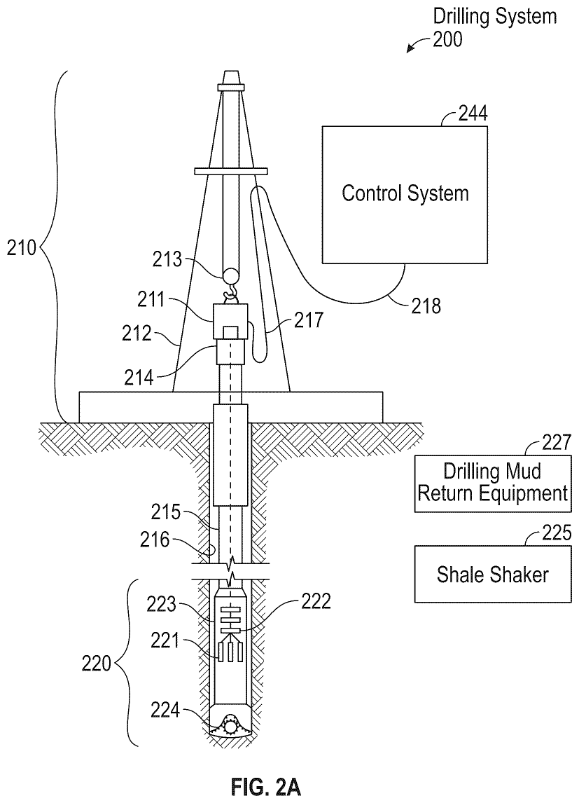

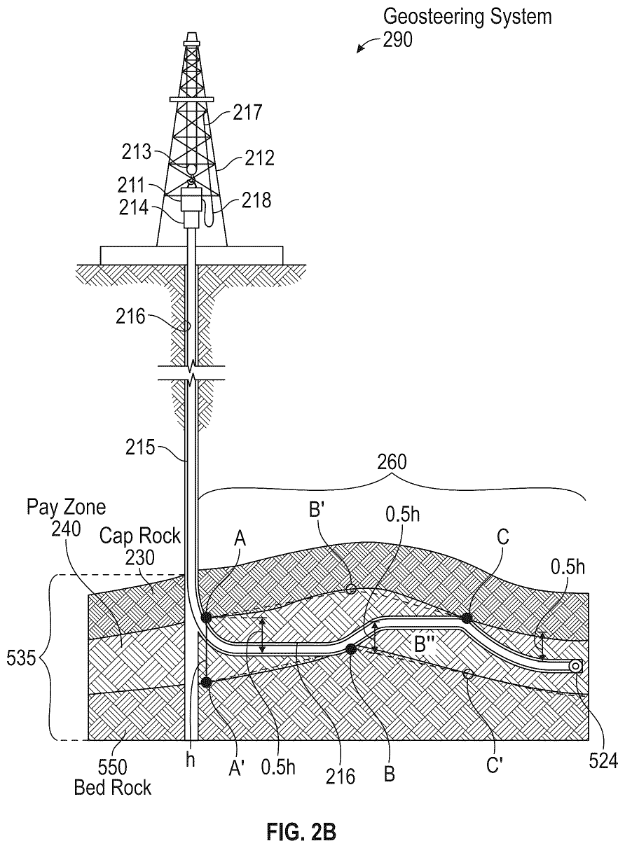

FIGS. 2A and 2B illustrate systems in accordance with one or more embodiments. As shown in FIG. 2A, a drilling system (200) may include a top drive drill rig (210) arranged around the setup of a drill bit logging tool (220). A top drive drill rig (210) may include a top drive (211) that may be suspended in a derrick (212) by a travelling block (213). In the center of the top drive (211), a drive shaft (214) may be coupled to a top pipe of a drill string (215), for example, by threads. The top drive (211) may rotate the drive shaft (214), so that the drill string (215) and a drill bit logging tool (220) cut the rock at the bottom of a wellbore (216). A power cable (217) supplying electric power to the top drive (211) may be protected inside one or more service loops (218) coupled to a control system (244). As such, drilling mud may be pumped into the wellbore (216) through a mud line, the drive shaft (214), and/or the drill string (215).

Moreover, when completing a well, casing may be inserted into the wellbore (216). The sides of the wellbore (216) may require support, and thus the casing may be used for supporting the sides of the wellbore (216). As such, a space (annulus) between the casing and the untreated sides of the wellbore (216) may be cemented to hold the casing in place. The cement may be forced through a lower end of the casing and into the annulus between the casing and a wall of the wellbore (216). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling mud, may be pumped into the casing above the cementing plug. This displacement fluid may be pressurized fluid that serves to urge the cementing plug downward through the casing to extrude the cement from the casing outlet and back up into the annulus.

During drilling operations, the drill string (215) is rotated relative to the wellbore (216), and weight is applied to the drill bit (224) to enable the drill bit (224) to break rock as the drill string (215) is rotated. While cutting rock with the drill bit (224), mud is pumped into the drill string (215).

The drilling fluid flows down the drill string (215) and exits into the bottom of the wellbore (216) through nozzles in the drill bit (224). The drilling fluid in the wellbore (216) then flows back up to the surface in an annular space between the drill string (215) and the wellbore (216) with entrained cuttings. The drilling fluid with the cuttings is returned to the drilling mud return equipment (227) to be circulated back again into the drill string (215). Typically, the cuttings are removed from the drilling fluid using a shale shaker (225) and the drilling fluid is reconditioned as necessary, before pumping the drilling fluid again into the drill string (215).

In one or more embodiments, cuttings removed from the drilling fluid by a shale shaker (225) may be analyzed using a cuttings analysis system to determine an obtained mineral composition of the cuttings. The observed mineral composition may then be compared to a predicted mineral composition of the sedimentary basin from a geological-time dependent salinity curve generated using Equations 2 or 3 according to embodiments herein.

In one or more embodiments, the cuttings analysis system includes drilling mud return equipment, configured to collect, adjust, and re-circulate drilling mud in the wellbore, a shake shaker, configured to separate cuttings from the drilling mud, and a cuttings analysis device, configured to obtain the observed mineral composition.

For cuttings analysis systems and methods, well-site geologists may conduct descriptions for the cutting lithology/mineralogy via visual estimations and/or use acid to verify carbonate minerals. In the lab, more accurate and quantitative determination of mineral compositions may be performed using cuttings analysis devices such as X-ray diffraction equipment, X-ray fluorescence equipment, and scanning electron microscopes (SEM) with energy dispersive spectroscopy.

The observed mineral composition of the cuttings may be measured by processes including on-site lab analysis, off-site lab analysis, chemical analysis, optical analysis, or other analysis techniques known to the art.

As further shown in FIG. 2A, sensors (221) may be included in a sensor assembly (223), which is positioned adjacent to a drill bit (224) and coupled to the drill string (215). Sensors (221) may also be coupled to a processor assembly (223) that includes a processor, memory, and an analog-to-digital converter (222) for processing sensor measurements. For example, the sensors (221) may include acoustic sensors, such as accelerometers, measurement microphones, contact microphones, and hydrophones. Likewise, the sensors (221) may include other types of sensors, such as transmitters and receivers to measure resistivity, gamma ray detectors, etc. The sensors (221) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling, or LWD), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (200) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

In one or more embodiments, drilling acoustic signals or other LWD data may be used to determine a mineral composition of a rock formation in a wellbore. The observed mineral composition may then be compared to a predicted mineral composition from a geological-time dependent salinity curve generated using Equations 2 or 3 according to embodiments herein.

The control system (244) may be coupled to the sensor assembly (223) in order to perform various program functions for up-down steering and left-right steering of the drill bit (224) through the wellbore (216). More specifically, the control system (244) may include hardware and/or software with functionality for geosteering a drill bit through a formation in a lateral well using sensor signals, such as drilling acoustic signals or resistivity measurements. For example, the formation may be a sedimentary basin containing a reservoir region, such as a pay zone, bed rock, or cap rock.

Turning to geosteering, geosteering may be used to position the drill bit (224) or drill string (215) relative to a boundary between different subsurface layers (e.g., overlying, underlying, and lateral layers of a pay zone) during drilling operations. In particular, measuring rock properties during drilling may provide the drilling system (200) with the ability to steer the drill bit (224) in the direction of desired hydrocarbon concentrations. As such, a geosteering system may use various sensors located inside or adjacent to the drilling string (215) to determine different rock formations within a wellbore's path. In some geosteering systems, drilling tools may use resistivity or acoustic measurements to guide the drill bit (224) during horizontal or lateral drilling.

Turning to FIG. 2B, FIG. 2B illustrates some embodiments for steering a drill bit through a lateral pay zone using a geosteering system (290). As shown in FIG. 2B, the geosteering system (290) may include the drilling system (200) from FIG. 2A. In particular, the geosteering system (290) may include functionality for monitoring various sensor signatures (e.g., an acoustic signature from acoustic sensors) that gradually or suddenly change as a well path traverses a cap rock (230), a pay zone (240), and a bed rock (250). Because of the sudden change in lithology between the cap rock (230) and the pay zone (240), for example, a sensor signature of the pay zone (240) may be different from the sensor signature of the cap rock (230). When the drill bit (224) drills out of the pay zone (240) into the cap rock (230), a detected amplitude spectrum of a particular sensor type may change suddenly between the two distinct sensor signatures. In contrast, when drilling from the pay zone (240) downward into the bed rock (250), the detected amplitude spectrum may gradually change.

During the lateral drilling of the wellbore (216), preliminary upper and lower boundaries of a formation layer's thickness may be derived from a geophysical survey and/or an offset well obtained before drilling the wellbore (216). If a vertical section (235) of the well is drilled, the actual upper and lower boundaries of a formation layer (i.e., actual pay zone boundaries (A, A′)) and the pay zone thickness (i.e., A to A′) at the vertical section (235) may be determined. Based on this well data, an operator may steer the drill bit (224) through a lateral section (260) of the wellbore (216) in real time. In particular, a logging tool may monitor a detected sensor signature proximate the drill bit (224), where the detected sensor signature may continuously be compared against prior sensor signatures, e.g., of the cap rock (230), pay zone (240), and bed rock (250), respectively. As such, if the detected sensor signature of drilled rock is the same or similar to the sensor signature of the pay zone (240), the drill bit (224) may still be drilling in the pay zone (240). In this scenario, the drill bit (224) may be operated to continue drilling along its current path and at a predetermined distance (0.5h) from a boundary of a formation layer. If the detected sensor signature is same as or similar to the prior sensor signatures of the cap rock (230) or the bed rock (250), respectively, then the control system (244) may determine that the drill bit (224) is drilling out of the pay zone (240) and into the upper or lower boundary of the pay zone (240). At this point, the vertical position of the drill bit (224) at this lateral position within the wellbore (216) may be determined and the upper and lower boundaries of the pay zone (240) may be updated, (for example, positions B and C in FIG. 2B). In some embodiments, the vertical position at the opposite boundary may be estimated based on the predetermined thickness of the pay zone (240), such as positions B′ and C′.

While FIGS. 2A, and 2B show various configurations of components, other configurations may be used without departing from the scope of the disclosure. For example, various components in FIGS. 2A, and 2B may be combined to create a single component or assembly. As another example, the functionality performed by a single component may be performed by two or more components.

An example geological-time dependent salinity curve generated by the methods described herein is shown in FIG. 3. The salinity curve (300) shown in FIG. 3 illustrates a relationship between the concentration of an ion in seawater (x-axis) and a point in geological time (y-axis). Geological time is related to the relative depth in the Earth's surface as sedimentary rocks were deposited over time during the formation of sedimentary basins. The mineral of interest modeled in FIG. 3 is anhydrite, but any mineral may be chosen which is of significance to the hydrocarbon reservoir region of interest. In one or more embodiments, an evaporite mineral was modeled because evaporites provide an excellent seal for hydrocarbons. Therefore, it is useful for the methods of one or more embodiments to obtain the location of evaporites in a hydrocarbon reservoir such that evaporite regions in the sedimentary basin may be avoided while determining a target location in a wellbore (since they are not likely to contain hydrocarbons).

Keeping with FIG. 3, as described above, the upper solubility (302) and lower solubility (304) limits for ion concentration in seawater may be determined by examining literature data. As shown by the right-most and left-most vertical lines on the salinity curve in FIG. 3, the upper limit (302) of anhydrite precipitation is 250 ppt and the lower limit (304) is 80 ppt. The upper limit (302) and lower limit (304) of anhydrite precipitation were determined based on extreme anhydrite environments located in the McLeod basin in Australia, as described in the method section above. These values will vary depending on the type of mineral, the mineral's location, and the geological-time period of interest.

For the specific example shown in FIG. 3, the salinity threshold (306) was calculated to be 185.6 ppt for anhydrite. The salinity threshold (306) line is the middle vertical line on the salinity curve (300) depicted in FIG. 3. As described above, the salinity threshold (306) is calculated by first determining the saturation index of anhydrite using Equation 1. The saturation index is used in combination with the seawater evaporation model, as described in the method section previously, to determine the salinity threshold (306) for anhydrite contained in a specific geological region during a specific range of geological-time. In general, the salinity threshold (306) marks a specific ion concentration in seawater required for a mineral to precipitate. When the ion concentration is greater than the salinity threshold, the mineral will precipitate (308) and when the ion concentration is less than the salinity threshold, the mineral will not precipitate (310).

Taking the salinity curve (300) of FIG. 3 as an example, the vertical line intersecting the X-axis at 185.6 ppt ion concentration in seawater shows the required ion concentration, or salinity threshold (306), for anhydrite to precipitate over a geological-time period of interest on the y-axis. Seawater having an ion concentration above 185.6 ppt at any point in geological-time would therefore have produced anhydrite layers by precipitation into a sedimentary basin. Thus, the region to the right of the salinity threshold line (308) of FIG. 3 may be used to predict points in time and therefore points in a wellbore which are likely to contain evaporite (anhydrite) regions. On the other hand, seawater having an ion concentration less than 185.6 ppt at any point in geological-time will not contain anhydrite layers because the salinity was not high enough for precipitation to occur. This is shown on the region to the left of the salinity threshold line (310) of FIG. 3, which represents regions of the wellbore that do not contain evaporite formations and therefore contain sedimentary rocks (in this example, carbonate) which are more likely to contain hydrocarbons. In one or more embodiments, a salinity threshold line (306) on a salinity curve (300) generated by the mathematical model developed herein in Equations 2 and 3 for a specific mineral at a specific time-period in geological history may be used to predict where different types of sedimentary rocks are located in a wellbore. Knowledge of which types of sedimentary rocks are located in a wellbore may be useful in one or more embodiments for determining hydrocarbon location and managing overpressure in a wellbore, for example.

In one or more embodiments, a mineral composition of an evaporite contained in a wellbore may be predicted by generating a geological-age dependent salinity curve. The predicted mineral composition of an evaporite may then be used to plan a wellbore path through a sedimentary basin containing hydrocarbons. In general, during well drilling operations, well data acquired through LWD or from cuttings retrieved from re-circulated mud may be used to make adjustments to drilling operations in real-time, such as rate of penetration (ROP), drilling direction, altering mud weight, and many others drilling parameters. Specifically, LWD or cuttings analysis may be used to determine an observed mineral composition of a location in the wellbore.

Using FIG. 3 as an example, a lower value of geological time (top of the y-axis) is more recent in the Earth's history which corresponds to rock formations that are closer to the surface of the Earth. As the geological time value increases, therefore, the depth with relation to the surface of the Earth increases. Thus, the direction of drilling (312) is illustrated in FIG. 3 as originating from the top of the x-axis to the bottom of the x-axis (i.e. lower to higher geological time and less depth to more depth compared to the surface of the Earth).

Once an observed mineral composition of a location in the wellbore is determined, the mineral composition may then be compared to the salinity curve which was generated based on the predicted mineral composition, such as the one shown in FIG. 3. The determined mineral composition may then be compared to a point on the salinity curve corresponding to a drilling position in the wellbore. If the point corresponding to the determined mineral composition falls at a point on the salinity curve where the predicted mineral composition does not match the observed mineral composition, the salinity curve may be calibrated to improve drilling operations. For example, point (314) on FIG. 3 (circle) represents a predicted ion concentration of about 90 ppt at 151.2 Ma in geological time. Because point (314) on FIG. 3 is less than the salinity threshold (306) of 185.6 ppt for anhydrite, it is determined that no evaporite rock should be present at this location in the wellbore. However, when drilling, the observed mineral concentration may be related to an ion concentration, such as point (316) (star) on the salinity curve (300) of FIG. 3, which shows the presence of evaporite at a point in the wellbore corresponding to 151.2 Ma geological time. Because points (314) and (316) on the salinity curve of FIG. 3 do not match, the salinity curve (300) may then be calibrated to obtain a corrected salinity threshold (306) to help improve drilling accuracy. To calibrate the geological-time dependent salinity curve of FIG. 3, the salinity threshold line (306) would therefore be shifted to a lower value of ion concentration (i.e., to the left on the x-axis). In doing so, the corrected salinity threshold would be slightly lower, allowing for an evaporite to precipitate at the observed concentration of 200 ppt (point 316) on FIG. 3. In one or more embodiments, the process of calibrating a salinity curve based on a predicted mineral composition may be repeated as many times as is desired while drilling a well. The calibration process of geological-time dependent salinity curves described herein allows for more accurate determination of hydrocarbon location in a wellbore.

In one or more embodiments, geological-time dependent salinity curves developed herein may be useful for overpressure management (or blowout prevention) in a wellbore based on a mineral composition observed during drilling. Overpressure in a well is defined as extremely high subsurface pressure which exceeds the hydrostatic pressure at the same depth. It is well known in the art that drilling a well through different types of geological rock formations, specifically those which trap large amounts of natural gas, is hazardous and may lead to a rapid, uncontrolled escape of over-pressurized fluids (also known as a blowout). To prevent blowout, drilling the well is usually conducted slowly and carefully, especially when formations suspected to contain large amounts of natural gas are encountered. Thus, obtaining information regarding which type of geological rock formation is present at a location in a wellbore would provide valuable information to help prevent well blowout. Furthermore, information regarding which type of geological rock formation is present in a wellbore may allow for ease of drilling operations because drilling can be conducted more carefully when formations likely to cause blowout are predicted to occur and drilling may ramp up when lower subsurface pressures are predicted to occur.

Blowout prevention is controlled by adjusting the weight of drilling mud which is circulated through the drill bit and up the annulus of a well. When the weight of drilling mud is increased, the hydrostatic pressure being exerted on the wellbore is increased, and vice versa. When subsurface pressure of a geological formation exceeds hydrostatic pressure, blowout is likely to occur. Therefore, a balancing of subsurface pressure and hydrostatic pressure exerted on the wellbore by adjusting the weight of drilling mud is crucial to blowout prevention.

In one or more embodiments, an observed mineral composition obtained, for example, by LWD information or cuttings analysis may be used to help prevent well blowouts. In one or more embodiments, the predicted mineral composition obtained from a geological-time dependent salinity curve is used to predict a sedimentary rock type, for example evaporite. The observed mineral composition may be compared to the predicted mineral composition on the salinity curve generated by Equations 2 or 3 according to embodiments disclosed herein. The observed mineral composition may then be used to calibrate the salinity curve for more accurate determination of sedimentary rock type in a sedimentary basin of a wellbore (for example, evaporite or carbonate). After calibration of a predicted salinity curve, a corrected salinity curve is obtained. In one or more embodiments, the corrected salinity curve may then be used to prevent well blowout by predicting when geological formations having high subsurface pressure will be approached during drilling. Furthermore, information regarding subsurface pressure of geological formations encountered during drilling may be used to adjust the weight of a drilling mud to help balance the hydrostatic pressure during drilling and prevent well blowout.

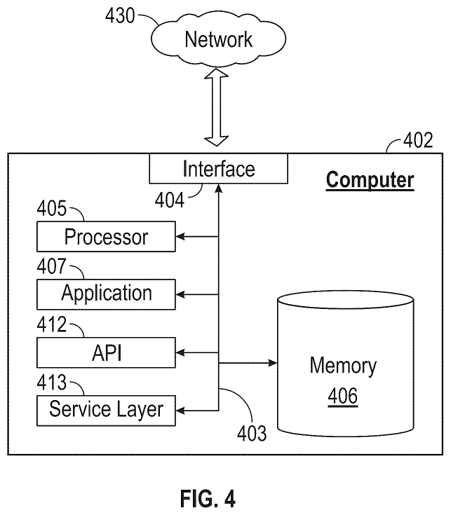

FIG. 4 depicts a block diagram of a computer system used to provide computational functionalities associated with described mathematical models, methods, functions, processes, flows, and procedures as described in this disclosure, according to one or more embodiments. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or another suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any mathematical models, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is a mathematical modeling software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), wherein each computer (402) communicates over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

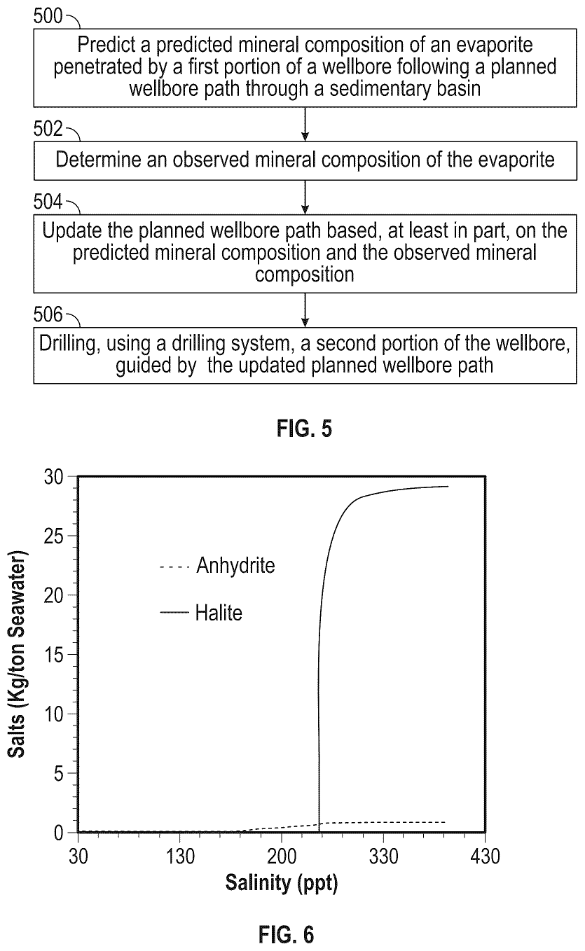

FIG. 5 shows a method in accordance with one or more embodiments. In step 500, a mineral composition of an evaporite penetrated by a first portion of a wellbore following a planned wellbore path through a sedimentary basin may be predicted. In some embodiments, predicting the predicted mineral composition may include generating a geological-time dependent salinity curve for a sedimentary basin, where the geological-time dependent salinity curve may be a relationship between the amount of minerals deposited in the sedimentary basin over a geological-time. In some embodiments, predicting the predicted mineral composition may include obtaining a predicted salinity threshold for each of at least one evaporite minerals. In some embodiments, predicting the predicted mineral composition may include determining the predicted mineral composition based, at least in part, on the geological-time dependent salinity curve and the predicted salinity thresholds. In some embodiments, predicting the predicted mineral composition may include calibrating the geological-time dependent salinity curve based on observed mineral composition collected in offset wellbores in the sedimentary basin. In some embodiments, predicting the predicted mineral composition may include adjusting a weight of drilling mud based, at least in part, on the predicted mineral composition of the evaporite. In some embodiments, the predicted mineral composition may be anhydrite. In some embodiments, generating a geological-time dependent salinity curve for a sedimentary basin may include obtaining a history of sea-level for the sedimentary basin. In some embodiments, generating a geological-time dependent salinity curve for a sedimentary basin may include using a seawater evaporation model to predict a salinity threshold and produce a seawater evaporation curve, where the seawater evaporation curve may be an amount of minerals contained in a body of seawater as a function of salinity. In some embodiments, generating a geological-time dependent salinity curve for a sedimentary basin may include identifying depositional portions of the history of sea-level. In some embodiments, generating a geological-time dependent salinity curve for a sedimentary basin may include developing a mathematical model to generate the geological-time dependent salinity curve based on the depositional portions of the history of sea-level. In some embodiments, using a seawater evaporation model to predict a salinity threshold and produce a seawater evaporation curve may include numerical simulation using the Harvie-Møller-Weare (HMW) model and PHREEQC software.

Keeping with FIG. 5, in step 502, an observed mineral composition of an evaporite is determined. In some embodiments, determining an observed mineral composition of the evaporite may include collecting drilling cuttings while drilling the first portion of the wellbore. In some embodiments, determining an observed mineral composition of the evaporite may include determining the observed mineral composition of the drilling cutting. In some embodiments, determining an observed mineral composition of the evaporite may include calibrating the geological-time dependent salinity curve based, at least in part, on the observed mineral composition. In other embodiments, determining an observed mineral composition of the evaporite may include collecting logging-while-drilling information while drilling the first portion of the wellbore.

Keeping with FIG. 5, in step 504, the planned wellbore path is updated based, at least in part, on the predicted mineral composition and the observed mineral composition.

Keeping with FIG. 5, in step 506, a second portion of the wellbore is drilled, using a drilling system, guided by the updated planned wellbore path.

### EXAMPLES

In the following examples, background geological data collected from various references and previously conducted studies, which have been previously used to generate conventional geological models, were used to show improved modeling capabilities when using salinity curves according to embodiments of the present disclosure. Additionally, in one or more embodiments, such background geological data collected from various references and previously conducted studies may be used as input data in combination with other data to generate geological-time dependent salinity curves according to embodiments of the present disclosure.

### Example 1

Example 1 shows how the seawater evaporation model useful for generating geological-time dependent salinity curves according to one or more embodiments presented herein is applied to real data.

The major ion composition of modern seawater is shown in Table 2, below. The modern seawater ion compositions shown in Table 2 were used to calculate late Jurassic seawater compositions based on fluid inclusion data described in Lu, P., Cantrell, D., Reactive transport modelling of reflux dolomitization in the Arab-D reservoir, Ghawar field, Saudi Arabia, Sedimentology, Vol. 63, No. 4, (Oct. 6, 2015), pp. 865-892. The calculated Jurassic seawater compositions were then input into the seawater evaporation model of the present embodiment to model mineral precipitation as a function of salinity, as shown in FIG. 6. In FIG. 6, seawater evaporation modeling was conducted by using the Harvie-Møller-Weare (HMW) model to calculate the evaporation pathway of Jurassic seawater in equilibrium with atmospheric carbon dioxide (CO₂) at 25° C., which was then input into the geochemical modeling software PHREEQC.

TABLE 2

| | Ion concentration, |
|---|---|
| Ion Type | at pH = 7.8 (milli-molal) |
| Ca²⁺ | 21 |
| Mg²⁺ | 36 |
| Na⁺ | 500 |
| K⁺ | 9 |
| Cl⁻ | 611 |
| HCO₃⁻ | 2.6 |
| SO₄²⁻ | 6 |

FIG. 6 shows the mass of minerals precipitated (in kg ion per ton of seawater) as predicted by the seawater evaporation model. Only anhydrite and halite are considered because they are the primary components of massive evaporites with sealing capacity during this time-period. Note that gypsum may have formed first during evaporation of Jurassic seawater, but gypsum would eventually convert to anhydrite during burial at temperatures greater than approximately 40° C. Therefore, for simplicity, anhydrite was used instead of gypsum. Anhydrite starts to precipitate at a salinity of 141 ppt parts per thousand (ppt), as shown in FIG. 6. The amount of precipitated anhydrite gradually increases with increasing salinity, but the rate of precipitation begins to slow at a salinity of greater than 185.6 ppt. The rate of precipitation of anhydrite reaches a maximum of about 0.82 kg/ton seawater at a salinity of approximately 400 ppt.

The other mineral considered in the seawater evaporation model is halite. Halite begins to precipitate at a salinity of approximately 267 ppt, as shown in FIG. 6. The amount of precipitated halite increases sharply with increasing salinity until about 300 ppt, where the rate of precipitation of halite begins to level off. The accumulated amount of halite precipitation reaches a value of about 29.1 kg/ton seawater at a salinity of approximately 400 ppt.

In summary, Example 1 illustrates the seawater evaporation model developed according to embodiments disclosed herein. The seawater evaporation model of Example 1 provides evaporite types (anhydrite and halite), the salinity threshold required for each mineral to precipitate (greater than 185.6 ppt for anhydrite and greater than 267 ppt for halite), and the amount of anhydrite and halite minerals produced as a function of salinity in Jurassic seawater in equilibrium with atmospheric CO₂ at 25° C. Note that the salinity threshold required for different minerals to precipitate will be different if the seawater composition is changed. It is well known that seawater composition underwent significant changes during the Earth's history.

### Example 2

Example 2 illustrates how the method to generate salinity curves according to the present embodiments is applied to real data. Example 2 uses the parameters determined from the seawater evaporation model of Example 1 as input (i.e., the evaporite types (anhydrite and halite), the salinity threshold required for each mineral to precipitate (greater than 185.6 ppt for anhydrite and greater than 267 ppt for halite)), and the amount of anhydrite and halite minerals produced as a function of salinity in Jurassic seawater in equilibrium with atmospheric CO₂ at 25° C.

Data from Grotsch, J., et al., The Arab Formation in central Abu Dhabi: 3-D reservoir architecture and static and dynamic modeling, GeoArabia, Vol. 8, No. 1, (2003), pp. 45-86 shows how the major evaporite anhydrite was formed in the Arab formation in central Abu Dhabi between the time-period of 153 to 148 Ma. A salinity curve was generated according to one or more embodiments herein to be used as input for 3D depositional modeling of the Arab Formation (see Example 3) in central Abu Dhabi and compared to modeling done by Grotsch, J., et al.

To generate a salinity curve for the Arab Formation in central Abu Dhabi, additional input data and information was obtained from the literature. However, in one or more embodiments, geological input data may be collected from experimentation, sensors, and/or other tools to identify and characterize geological formations in real time or prior to generating salinity curve models disclosed herein.

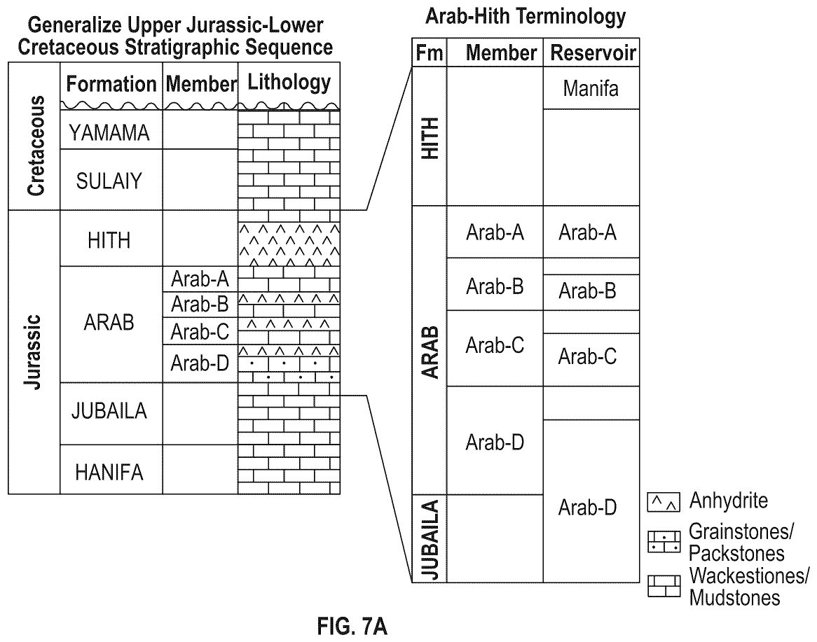

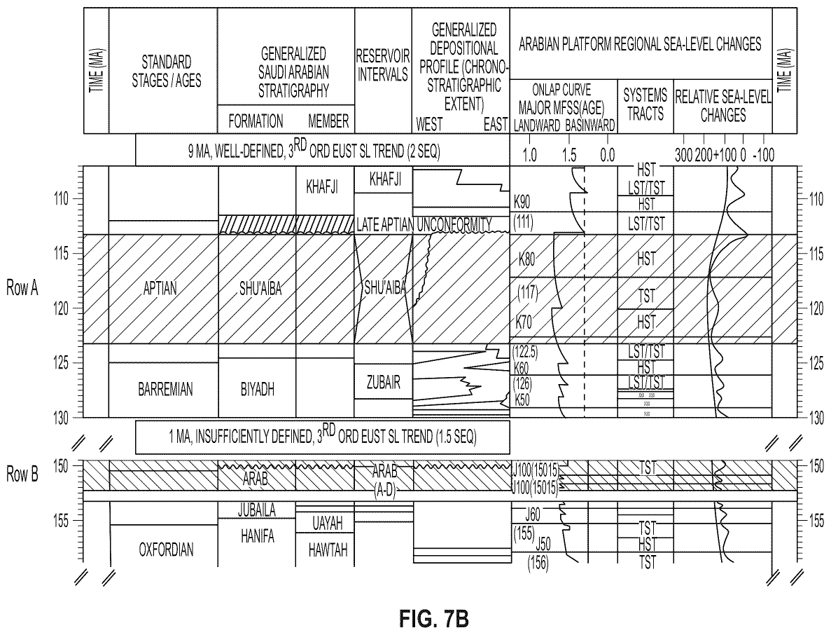

For Example 2, input data included data from Grotsch, J., et al., as well as Linsay, R. F., Cantrell, D. L., Hughes, G. W., Keith, T. H., Mueller III, H. W., Russell, S. D., Ghawar Arab-D Reservoir: Widespread Porosity in Shoaling-upward Carbonate Cycles, Saudi Arabia, Giant Hydrocarbon Reservoirs of the World: From rocks to reservoir characterization and modeling: AAPG Memoir 88 SEPM Special Publication, p. 97-137 (2006), and Haq, B. U., Al-Qahtani, A. M., Phanerozoic cycles of sea-level change on the Arabian Platform, GeoArabia, Vol. 10, No. 2, (2005). pp. 127-160, each of which is incorporated herein by reference. Data from sequence stratigraphic studies in central Abu Dhabi by Linsay et al. shows that the Upper Jurassic intervals comprise a series of thinly bedded dolomite and limestone units interbedded with impermeable anhydrite layers as shown in FIG. 7A. Also, FIG. 7B shows a time span ranging from 153-148 Ma (Pink box) covering the Upper Arab-D, Arab A-C and Hith Member for the stacked evaporite-carbonate sedimentary modeling. The stacked carbonate-evaporite successions are characterized by shallowing-upward, aggradational and progradational cycles (FIG. 7B). The time span used as input data for Example 2 was determined based on literature data. Simulation time span was determined from coring and logging data collected by Grotsch, J., et al. and from the lithography and sequence stratigraphy study from Haq, et al. (shown in part in FIG. 7B). Four time-periods of significant evaporation in the Arab intrashelf basin-infill cycle which are relevant to development of the salinity curves of the present embodiment were estimated to be [149.6, 148.4] Ma, [150.8, 150] Ma, [152, 151.2] Ma and [153, 152.4] Ma.

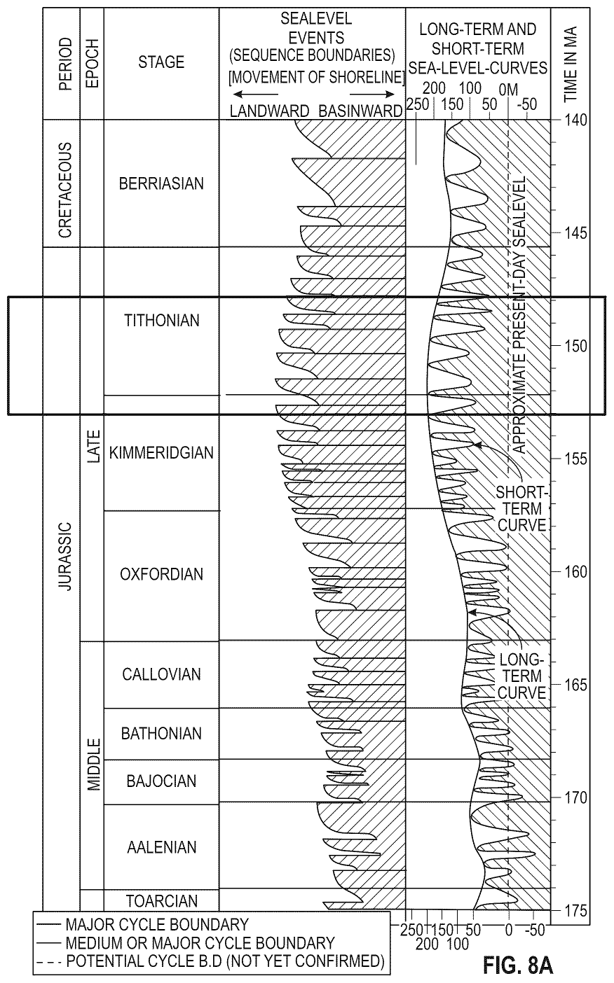

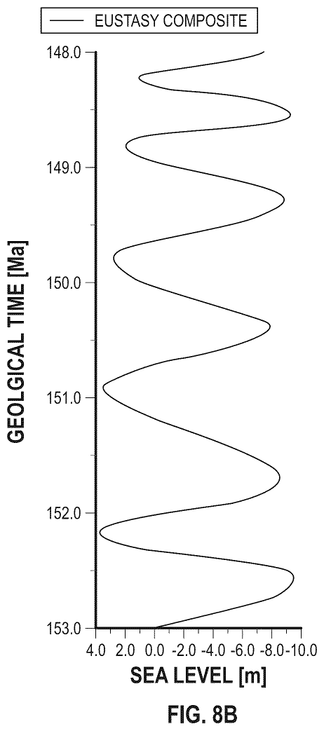

The most recent sea level curve for the area, as determined by Haq, et al. was used in addition to the estimated evaporation periods, as well as anhydrite salinity upper and lower limits as determined from background geological data discussed above to develop the salinity curve. The sea level curve used as input data for Example 2 was determined based on literature data. FIG. 8A shows middle-late Jurassic sequence and variations in sea-level as reported by Haq, et al. The red box in FIG. 8A gives the geological-time period of interest for the modeling of Example 2. The sea-level curve adapted from the information in FIG. 8A is shown in FIG. 8B.

The resulting salinity curve generated by the method and mathematical model described by embodiments herein is shown in FIG. 9. The information in the box on the lefthand side of FIG. 9 shows the input data which was determined from background geological data. The background geological data is then combined with the most recent sea level curve for the Arab intrashelf basin (FIG. 9, center) to generate a salinity curve for anhydrite, shown in FIG. 9 (righthand side).

### Example 3

Example 3 is a case study on integrated diagenetic-depositional modeling of stacked evaporite-carbonate sedimentary basins, which illustrates how the salinity curve developed in Example 2 is used as input for 3D depositional modeling of the Arab Formation in central Abu Dhabi and compared to modeling done by Grotsch, J., et al.

The salinity curve of Example 2 was used for integrated diagenetic-depositional modeling of the Arab Formation in central Abu Dhabi based on the input data described for Example 1 and Example 2, as well as additional input data and information obtained from the literature. In summary, the input data for Example 1 includes evaporite types, salinity threshold, and the amount of anhydrite and halite minerals produced as a function of salinity in Jurassic seawater in equilibrium with atmospheric CO₂ at 25° C. Additional input data for Example 2 includes four relevant evaporation time periods, determined to be [149.6, 148.4] Ma, [150.8, 150] Ma, [152, 151.2] Ma and [153, 152.4] Ma, and the most recent sea level curve for the Arab Formation.

Additional information required for the modeling in Example 3 was obtained from the literature as follows.

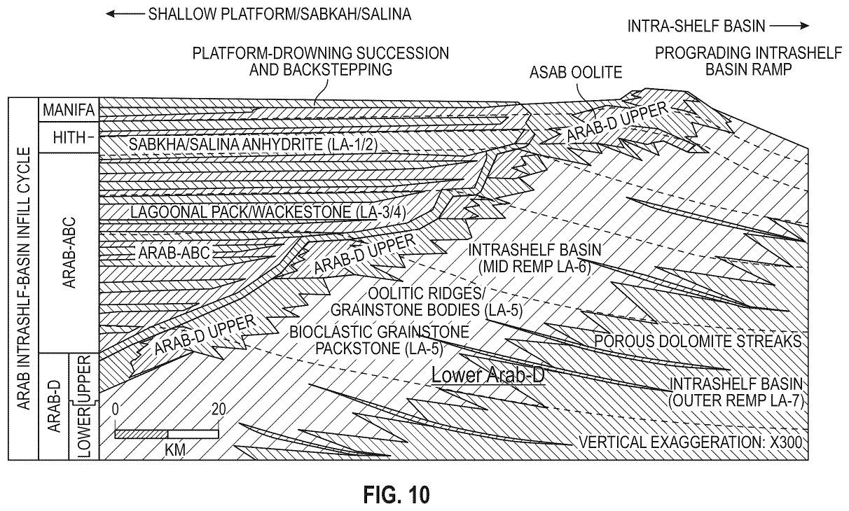

FIG. 10 shows a schematic block diagram of the lithofacies association in central Abu Dhabi. Lithostratigraphic units (lithofacies) are defined as formation/member name, for example, the Upper Arab-D. The Upper Arab-D portion includes oolitic and bioclastic grainstone section/belts, while the Lower Arab-D portion is a time-transgressive deposit of middle to deep ramp environments (See yellow and orange regions in FIG. 10) within the Arab intrashelf basin on the Arabian Platform. The high-frequency carbonate-anhydrite shallowing-upward cycles are defined as the combined Arab-ABC interval (See light pink and green area in FIG. 10). The classifications or definitions shown in FIG. 10 are strictly lithostratigraphic and bear no chronostratigrahic implication.

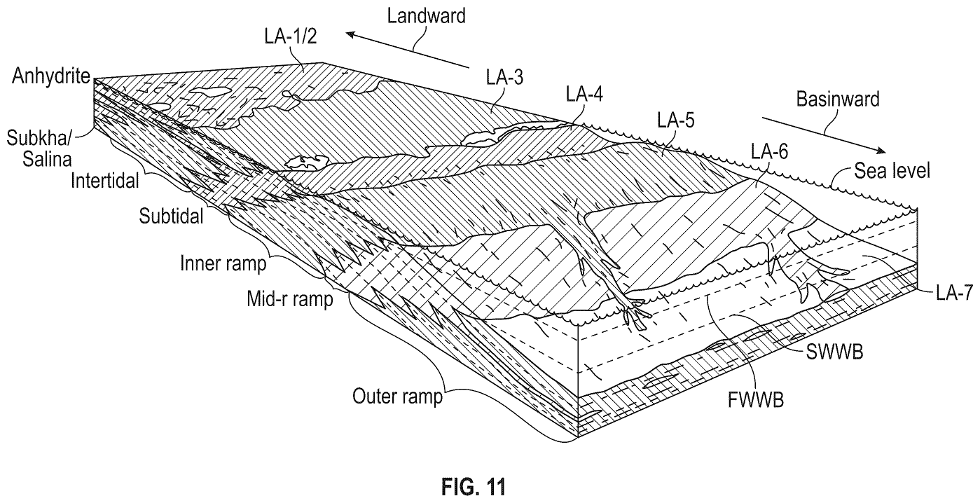

FIG. 11 shows a paleo-environment 3D conceptual model of the observed lithofacies associations of the Arab intrashelf basin infill cycle in central Abu Dhabi, where time-equivalent lines are marked in black dash lines. The different lithostratigraphic units that are laterally (from landward to basinward) time equivalent, represent a complete carbonate ramp-intrashelf basin depositional system. The time-equivalent facies distribution of the Arab Formation from landward to intrashelf basin includes Sabkha and salina anhydrite in supratidal to intertidal environments (LA-1/2 in FIGS. 10 and 11), intertidal to subtidal lagoonal pack/wackestone (LA-3/4 in FIGS. 10 and 11), oolitic and bioclastic grainstones in shoreline to inner ramp environments (LA-5 in FIGS. 8 and 11), oolitic grainstones to bioturbated wackestone in a mid-ramp environment (LA-6 in FIGS. 10 and 11), and wackestone to mudstone in an outer ramp environment (LA-7 in FIGS. 10 and 11).

In FIG. 10, the red dashed lines represent the sequence stratigraphic architecture based on the chronostratigraphic interpretation as described above. The chronostratigraphic interpretation describes the Arab intrashelf basin-infill cycle (including Arab A, B, C, D, Hith, and Manifa). During deposition of the Arab A to D members, the entire ramp system prograded towards the intrashelf basin. In chronostratigraphic terms, the carbonate-anhydrite shallowing-upward cycles are time-equivalent to strong progradation during their top deposition, with thicker anhydrite intercalations in the lagoonal (platform) areas. Thick Hith Anhydrite is time-equivalent to the Asab Oolite and mid-ramp deposits, which indicates maximum progradation with minimum accommodation space for carbonate growth created on the platform. The drowning succession of the Manifa Formation indicates the end of the Arab ramp-instrashelf basin cycle.

The structural data presented in FIG. 10 show that the late Jurassic and early Cretaceous eras of the Arab formation in central Abu Dhabi were devoid of major tectonic activity, as supported by the evidence of only small lateral thickness variations. By the time of the Late Cretaceous era (Campanian to Maastrichtian), compressional tectonic movements caused wrench faulting and folding in onshore Abu Dhabi and thrusting along the Oman Mountain front, which shaped the present-day anticlinal structure of the studied area.

Additional model input parameters, therefore, are summarized in the following paragraphs.

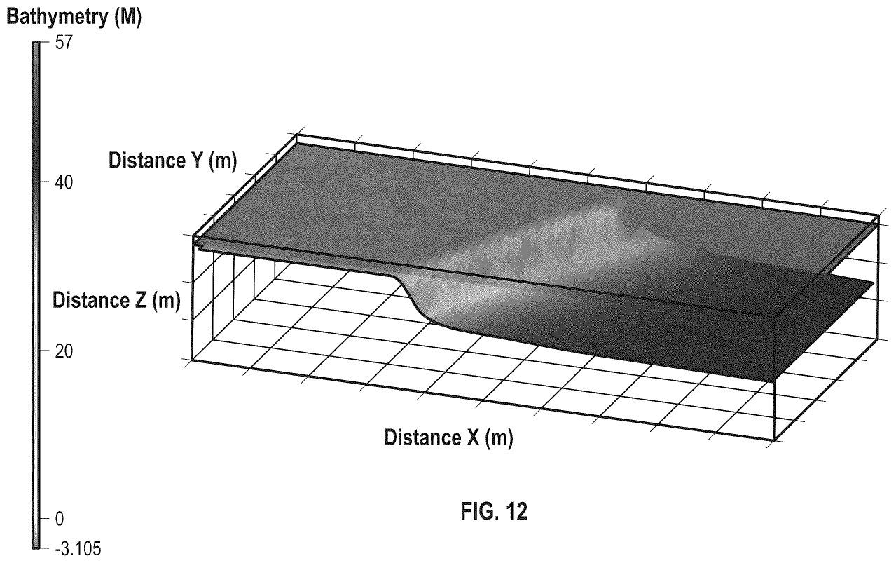

The initial bathymetry map used as input data for Example 2 was determined based on literature data as discussed above. The bathymetry map is one of the basic and key input data for modeling. Usually, they are from the estimation of the paleo-bathymetry based on seismic interpretation and other geological study. The initial bathymetry map for the modeling scenario is estimated and constructed based on the general tidal carbonate platform/ramp geometry as shown in FIG. 12.

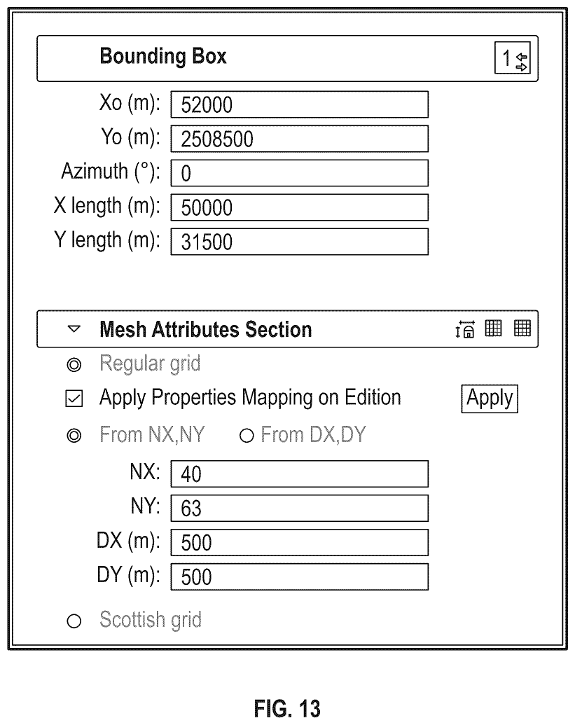

The domain parameters used as input data for Example 3 were determined based on literature data as discussed above. Domain parameters input into the model of Example 3 are shown in FIG. 13. FIG. 13 provides the parameters for the model size in X and Y (length 20000, 315000, grid increment 500 and node number 40, 63). However, these parameters may change based on specific areas.

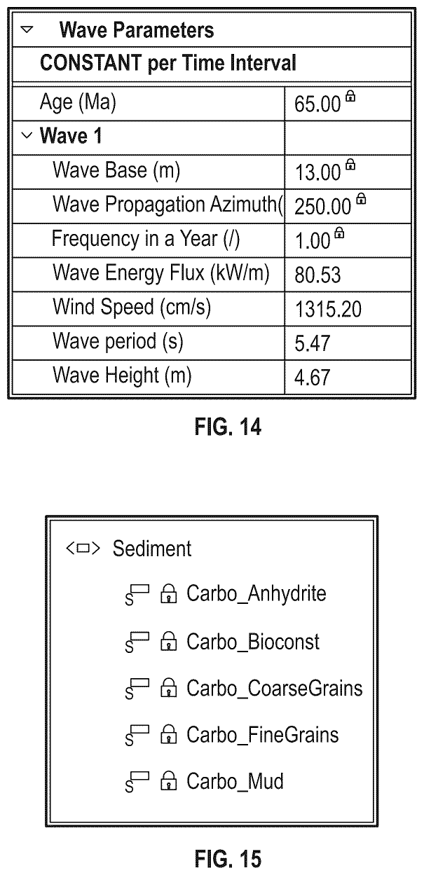

The wave parameters used as input data for Example 2 were determined based on literature data as discussed above. Wave parameters input into the model of Example 2 are shown in FIG. 14. The wave parameters in FIG. 14 are parameters that control the ocean wave energy. Wave energy parameters are also one of the key inputs for the modeling because they can influence the distribution of the sediment location with different values. These values are empirical and may be tuned to make sure the general sedimentary patterns are fit to the observation.

Five sediment evaporation types used as input data for Example 2 were determined from both literature data as discussed above and a “toolbox” proprietary software that may be used to generate graphics from the evaporation models and prepare inputs for the depositional modeling automatically. Sediment types include, for example, coarse grain, fine grain, mud and bioclastic for carbonate deposits (for lagoon, ramp and open marine), anhydrite for evaporite derived from literature study, as shown in FIG. 15. The main facies/environment producing anhydrite in the studied system is the supratidal to intertidal area.

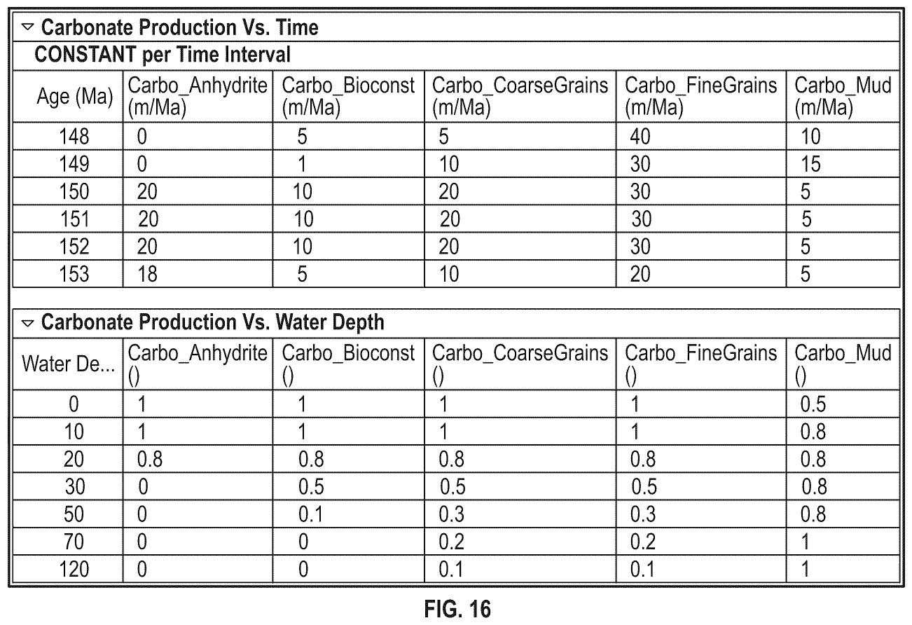

The carbonate production data used as input data for Example 2 was determined based on literature data as discussed above. Carbonate production data input for the model of Example 2 is shown in FIG. 16. The parameters in FIG. 16 control the sediments' production speed and water depth. Together with the wave energy, these values may be tuned to make sure the sediment distribution depths are fit to the observation. Carbonate production values are empirical.

In summary, input parameters for the diagenetic integrated diagenetic-depositional modeling of stacked evaporite-carbonate sedimentary basins model generated herein as Example 3 are as follows. Four evaporation periods (EP) in the Arab intrashelf basin-infill cycle which are relevant to development of the salinity curves of the present embodiment were estimated to be [149.6, 148.4] Ma, [150.8, 150] Ma, [152, 151.2] Ma and [153, 152.4] Ma based on data from of Grotsch, J., et al., and lithography and sequence stratigraphy study from Haq, et al. (shown in part in FIG. 7B). Based on the formation information described above and shown in Table 2, a lower limit (LL) for anhydrite salinity was determined to be 85 ppt and an upper limit (UL) was determined to be 249 ppt. Other key input parameters for the modeling include the domain definition (shown in FIG. 13), bathymetric map of the region (shown in FIG. 12), sea-level changes (shown in FIGS. 8A and 8B), wave parameters (shown in FIG. 14), evaporite types (FIG. 15), and carbonate production (FIG. 16).

### Model Results

In one or more embodiments, the salinity curves generated by Equation 2 or Equation 3 may be implemented into process-based depositional modeling (forward modeling) to improve the resolution and quality of stacked carbonate-evaporite models and to reduce uncertainties in predicting stratigraphic traps. Example 3 illustrates 3D depositional modeling of the Arab Formation in central Abu Dhabi according to embodiments presented herein as compared to modeling by Grotsch, J., et al.

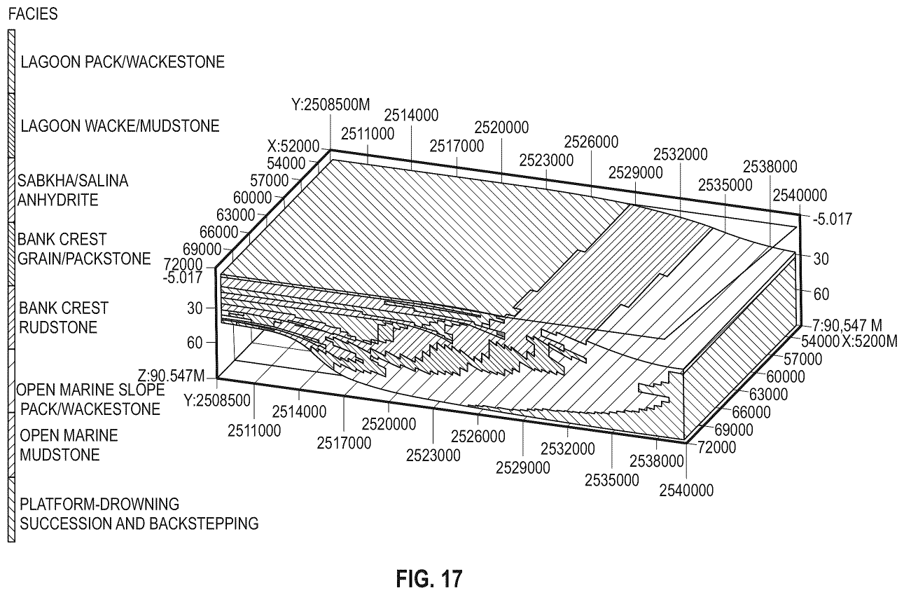

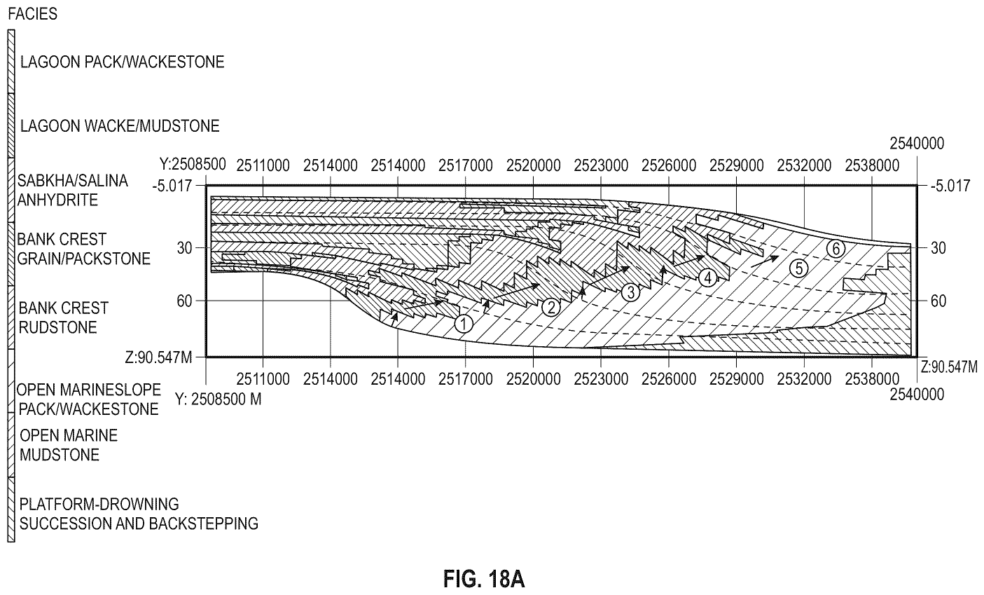

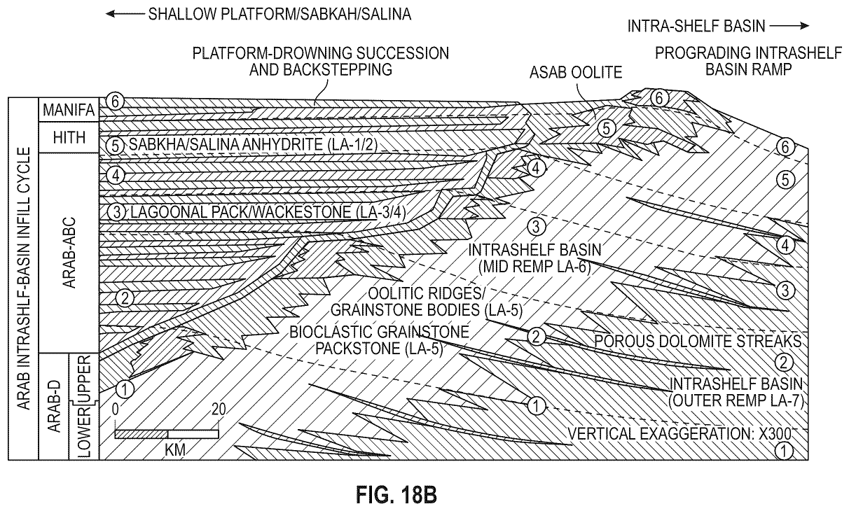

FIG. 17 shows results of the diagenetic modeling using the salinity curve developed herein (FIG. 9) and the input data as described above. Overall, the model results of FIG. 17 match depositional patterns and facies trends of the schematic depositional facies distribution of the Arab intrashelf-basin infill cycle shown in the model results by Grotsch, J., et al., shown in FIG. 18B.

The lithofacies distribution is shown from the shallow marine platform to the basin downslope, where eight depositional lithofacies have been constructed in the depositional model illustrated in FIG. 17, including: (1) sabkha/salina anhydrite (a salina to peritidal to intertidal setting), (2) lagoonal pack-/wackestone and (3) lagoonal wacke-/mudstone (an intertidal to subtidal inner-ramp lagoon setting), (4) bank crest grain-/packstone and (5) bank crest rudstone (a shoreline to inner ramp environment with oolitic and bioclastic grainstones), (6) open marine slope pack-/wackestone and (7) open marine mudstone (an outer ramp environment with micrite), and (8) platform drowning succession and backstripping.

3D depositional modeling results according to Example 3 of embodiments herein show shallowing-upward cycles, as depicted in FIG. 18A. The entire depositional system is composed of six cycles (FIG. 18A), and therefore the model is consistent with the stratigraphic information derived from well and seismic data which was modeled by Grotsch, J., et al., as shown in FIG. 18B. During cycles 1-4 (Upper Arab D to Arab ABC), the ramp features basinward progradation. Each cycle repeats a pattern of initial aggradation followed by progradation resulting in a shallowing-upwards pattern across the platform top, i.e. lagoonal deposits capped by thicker anhydrite layers. Laterally from landward to basinward, the carbonate-anhydrite shallowing-upward cycles transit to a carbonate ramp regime. Anhydrite salina deposition usually occurred during an initial relative sea-level rise subsequent to major fall with subaerial exposure of the ramp top. Cycle 5 corresponds to the thick Hith Anhydrite which laterally grades to the time-equivalent Asab Oolite and deeper mid-ramp deposits. Cycle 5 shows the maximum progradation of the system triggered by a pronounced sea-level fall and, consequently, minimum accommodation space for carbonate growth. Cycle 6 corresponds to the Manifa Formation, when major back-stepping of the ramp took place, indicating the end of the Arab intrashelf-basin cycle and the onset of renewed progradation in the Early Cretaceous.

Despite very limited well data availability, the modeled total thickness of 46-85 m adequately reflects actual thicknesses of the Abu Dhabi Arab intrashelf-basin infill, which are reported to be about 68 m on average. The observed well data show a distinct high-frequency cycle stacking pattern. The stacking pattern indicates high-frequency variations in accommodation space, possibly at Milankovitch time scales (approx. 18-400 Ky in the Mesozoic). However, the diagenetic model presented herein assumes the accommodation space is mainly controlled by lower frequency sea-level variations of 1-3 million years (My) (as shown by third order sea-level changes). Due to the limited temporal resolution sea-level changes in the model (FIG. 8A), only the major thick anhydrite levels, often capped with subaerial exposure (FIG. 18B), could be incorporated.

In conclusion, 3D depositional modeling results according to Example 3 of embodiments herein provide the following advantages as compared to other modeling types, such as that shown in FIG. 18B by Grotsch, J., et al. The model according to Example 3 incorporates evaporite chemical processes (i.e. the geochemical equilibrium model of Equation 1), which has not been observed in previous models for process-based depositional modeling of peritidal carbonate platforms. Also, geological-time dependent salinity curves modeled herein as Equations 2 and 3 provide salinity data over time, which has not been incorporated into previous models. Implementing salinity curves into 3D depositional modeling according to embodiments herein also improves the resolution and predictive quality of reservoirs and stratigraphic trap models for carbonate-evaporate sedimentary basins and significantly reduces model uncertainties as compared to previous modeling techniques.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. Although multiple dependent claims are not introduced, it would be apparent to one of ordinary skill that the subject matter of the dependent claims of one or more embodiments may be combined with other dependent claims.

What is claimed:

1. A method, comprising:
predicting a predicted mineral composition of an evaporite penetrated by a first portion of a wellbore following a planned wellbore path through a sedimentary basin;
determining an observed mineral composition of the evaporite;
updating the planned wellbore path based, at least in part, on the predicted mineral composition and the observed mineral composition; and
drilling, using a drilling system, a second portion of the wellbore, guided by the updated planned wellbore path.

2. The method of claim 1, wherein predicting the predicted mineral composition comprises:
generating a geological-time dependent salinity curve for a sedimentary basin, wherein the geological-time dependent salinity curve comprises a relationship between the amount of minerals deposited in the sedimentary basin over a geological-time;
obtaining a predicted salinity threshold for each of at least one evaporite minerals; and
determining the predicted mineral composition based, at least in part, on the geological-time dependent salinity curve and the predicted salinity thresholds.

3. The method of claim 2, wherein predicting the predicted mineral composition further comprises calibrating the geological-time dependent salinity curve based on observed mineral composition collected in offset wellbores in the sedimentary basin.

4. The method of claim 2, wherein predicting the predicted mineral composition further comprises:
collecting drilling cuttings while drilling the first portion of the wellbore;
determining the observed mineral composition of the drilling cutting from the drilling cuttings; and
calibrating the geological-time dependent salinity curve based, at least in part, on the observed mineral composition.

5. The method of claim 2, wherein predicting the predicted mineral composition further comprises:
collecting logging-while-drilling information while drilling the first portion of the wellbore;
determining the observed mineral composition of a rock formation based on logging-while-drilling information; and
calibrating the geological-time dependent salinity curve based, at least in part, on the observed mineral composition.

6. The method of claim 1, further comprising adjusting a weight of drilling mud based, at least in part, on the predicted mineral composition of the evaporite.

7. The method of claim 1, wherein the predicted mineral composition comprises anhydrite.

8. The method of claim 2, wherein generating a geological-time dependent salinity curve for a sedimentary basin further comprises:
obtaining a history of sea-level for the sedimentary basin;
using a seawater evaporation model to predict a salinity threshold and produce a seawater evaporation curve, wherein the seawater evaporation curve comprises an amount of minerals contained in a body of seawater as a function of salinity;
identifying depositional portions of the history of sea-level; and
developing a mathematical model to generate the geological-time dependent salinity curve based on the depositional portions of the history of sea-level.

9. The method of claim 8, wherein using a seawater evaporation model to predict a salinity threshold and produce a seawater evaporation curve further comprises numerical simulation using the Harvie-Møller-Weare (HMW) model and PHREEQC software.

10. A non-transitory computer readable medium storing instructions executable by a computer processor, the instructions when executed by a computer processor comprise steps of:
receiving a history of sea-level for a sedimentary basin;
using a seawater evaporation model to predict a salinity threshold and produce a seawater evaporation curve, wherein the seawater evaporation curve comprises an amount of minerals contained in a body of seawater as a function of salinity;
identifying depositional portions of the history of sea-level; and
developing a mathematical model to generate the geological-time dependent salinity curve based on the depositional portions of the history of sea-level.

11. A non-transitory computer readable medium of claim 10, the steps further comprising:
numerical simulation using the Harvie-Møller-Weare (HMW) model and PHREEQC software.

12. A system, comprising:
a geological-time dependent salinity curve, configured to predict a predicted mineral composition in a sedimentary basin;
a drilling system, configured to drill a wellbore through the sedimentary basin; and
a calibrated geological-time dependent salinity curve, configured to predict a second mineral composition based on an observed mineral composition.

13. The system of claim 12, further comprising
a wellbore planning system with functionality for geosteering, configured to plan a planned wellbore trajectory to reach the drilling target;
wherein the drilling system is configured to drill the wellbore guided by the planned wellbore trajectory.

14. The system of claim 12, further comprising:
a cuttings analysis system, configured to obtain the obtained mineral composition pertaining to a sedimentary basin, wherein the cuttings analysis system comprises:
drilling mud return equipment, configured to collect, adjust, and re-circulate drilling mud in the wellbore;
a shale shaker, configured to separate cuttings from the drilling mud; and
a cuttings analysis device, configured to obtain the observed mineral composition.

15. The system of claim 12, further comprising a well logging tool, configured to obtain the obtained mineral composition pertaining to the sedimentary basin from the wellbore.
